(19) United States
(12) Patent Application Publication
(10) Pub. No.: US 2026/0283902 A1
(43) Pub. Date: Sep. 24, 2026

(54) LAP-STABILIZED SELF-MASSAGE APPARATUS WITH ERGONOMIC HANDLE AND METHODS OF SELF-MASSAGE

(71) Applicant: Therapy Grip LLC, Sheridan, WY (US)

(72) Inventors: David Wayne Morris, Rufus, OR (US); Roger McMunn, Gresham, OR (US)

(21) Appl. No.: 19/569,823

(22) Filed: Mar. 17, 2026

Related U.S. Application Data
(60) Provisional application No. 63/776,843, filed on Mar. 24, 2025.

(51) Int. Cl. A61H 37/00; A61H 23/02

(52) U.S. Cl. CPC A61H 37/00; A61H 23/0254; A61H 2201/1628; A61H 2201/1635; A61H 2205/04; A61H 2205/081

(57) ABSTRACT

A self-massage apparatus includes an ergonomic handle to which a powered massager gun may be attached. The handle includes an elongate body with a curved middle section that extends between the first and second end portions and is shaped and sized to be lap-supported and to facilitate positioning the massager gun at the user's back while manipulating the handle in front of the user in a neutral arm and hand position. A convex side of the curved middle section is continuously curved to allow the middle section to be slidable over the user's lap to facilitate positioning of the massager gun at various positions between the user's lower back and their neck.

### RELATED APPLICATIONS

This is a non-provisional of and claims the benefit of priority under 35 U.S.C. § 119(e) from U.S. Provisional Patent Application No. 63/776,843, filed Mar. 24, 2025, the disclosure of which is incorporated herein by reference.

### TECHNICAL FIELD

The field of the present disclosure relates to self-massage devices and methods for personal care, muscle conditioning, and/or muscle therapy, and especially to a powered massage device and an ergonomic handle thereof, which facilitate self-massage of difficult-to-reach areas of the user's body.

### BACKGROUND

Muscular pain and tension relief are commonly sought through various forms of massage therapy. Handheld massager guns such as percussion massagers have become increasingly popular for personal use. However, it is difficult for a user to reach their own back, shoulders, and lower extremities for self-application of massage using such devices. Orienting and applying a hand-held massager gun to such difficult-to-reach areas necessitates dexterous engagement of the very same muscle groups as are targeted, which inhibits relief of pain and/or tension. Numerous “massager on a stick” extension aids and other elongate devices for self-massage of the back and other hard-to-reach areas are known, such as those described in patent document Nos. US 2023/0027314; US 2022/0117841; U.S. Pat. Nos. 11,974,956; 11,633,324; and 6,758,826. However, these existing devices still require significant activation and engagement of the targeted muscles when applying massage to such hard-to-reach areas, hindering effectiveness and utility for individuals with specific limitations, such as back injuries, reduced dexterity, and/or reduced mobility.

The inventor has recognized a previously unmet longstanding need for an effective method of self-applied massage that does not require activation of the targeted muscle groups, contortion, and/or assistance from others.

### BRIEF DESCRIPTION OF THE DRAWINGS

A detailed description of preferred embodiments proceeds with reference to the accompanying drawings listed below. Identical reference numbers appearing in multiple figures of the drawings refer to the same element throughout.

FIG. 1 is a pictorial view illustrating use of a massager system in accordance with an embodiment.

FIG. 2 is an exploded assembly view of the massager system of FIG. 1, showing components of a massager gun, an ergonomic handle, and a clamp for mounting the massager gun to the handle.

FIG. 3 is an enlarged detail view of an end portion of the extension handle of FIG. 1 showing details of a mounting system for securing a massager gun to the handle.

FIG. 4 is an exploded view of a three-piece curved ergonomic handle for a massager system in accordance with another embodiment.

FIG. 5 is a perspective view of an extension handle for a massager system.

FIG. 6 is a right side elevation view of the extension handle of FIG. 5, the left side being a substantial mirror image.

FIG. 7 is a rear elevation view of the extension handle of FIG. 5.

FIG. 8 is a front elevation view of the extension handle of FIG. 5.

FIG. 9 is a top view of the extension handle of FIG. 5.

FIG. 10 is a bottom view of the extension handle of FIG. 5.

### DETAILED DESCRIPTION OF EXEMPLARY EMBODIMENTS

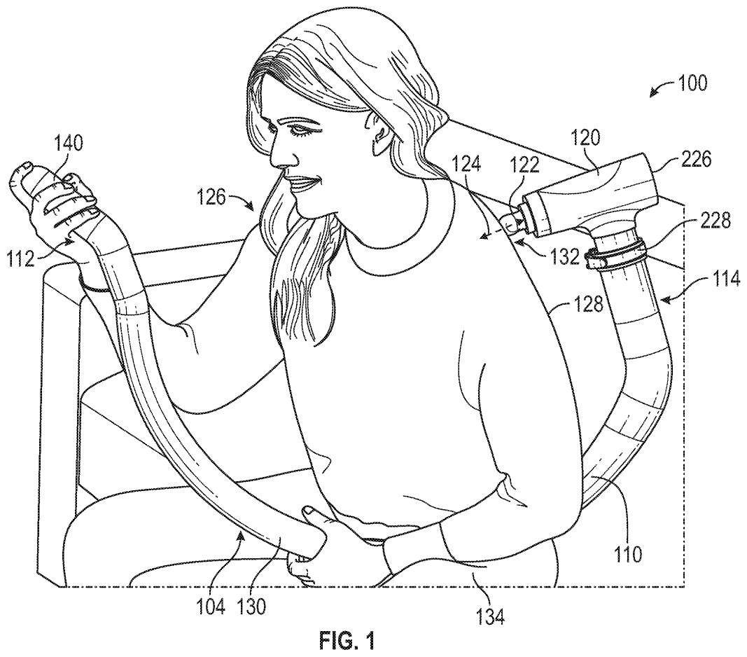

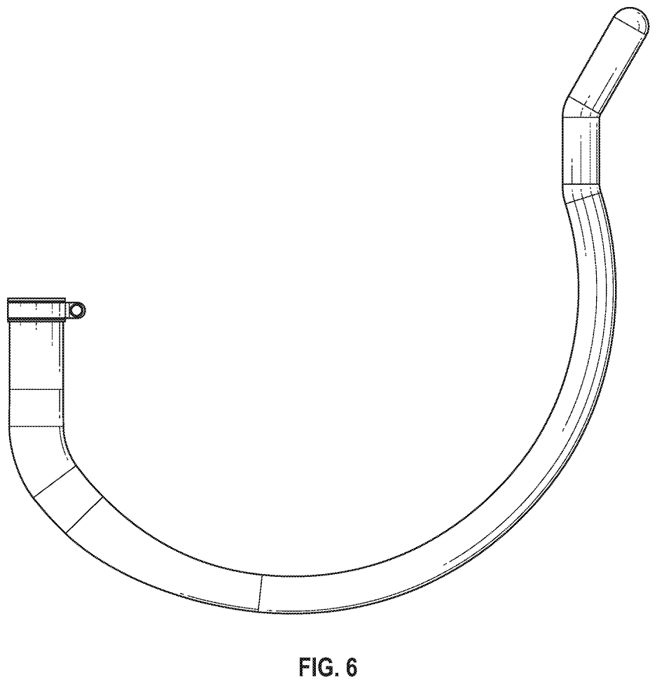

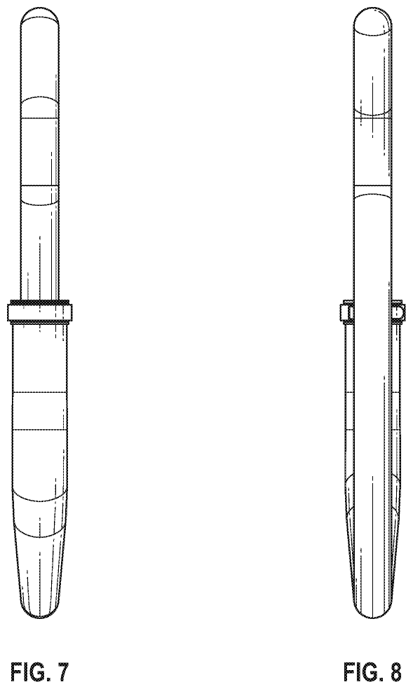

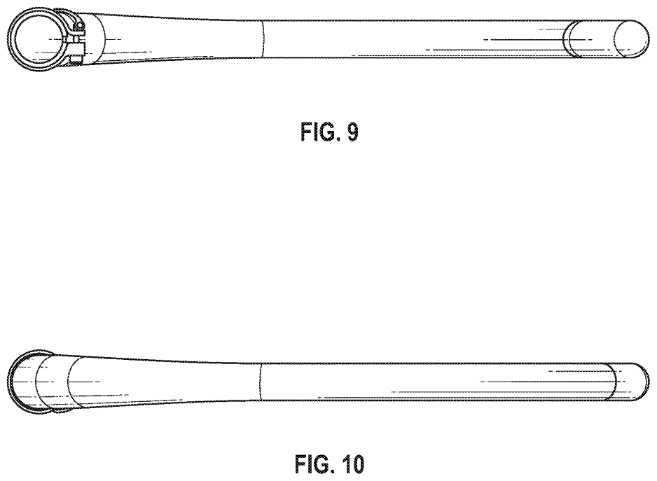

A massager system, described in further detail herein with reference to FIGS. 1-10, includes an ergonomic handle and massager gun that offers the potential to provide self-applied massage therapy. Specifically, the massager system can be used by individuals with limited reaching capabilities, flexibility, or strength. The handle of the massager system may facilitate ease of use for handheld massager guns, such as battery-powered percussion massagers, by eliminating the need for complex muscle group engagement during operation.

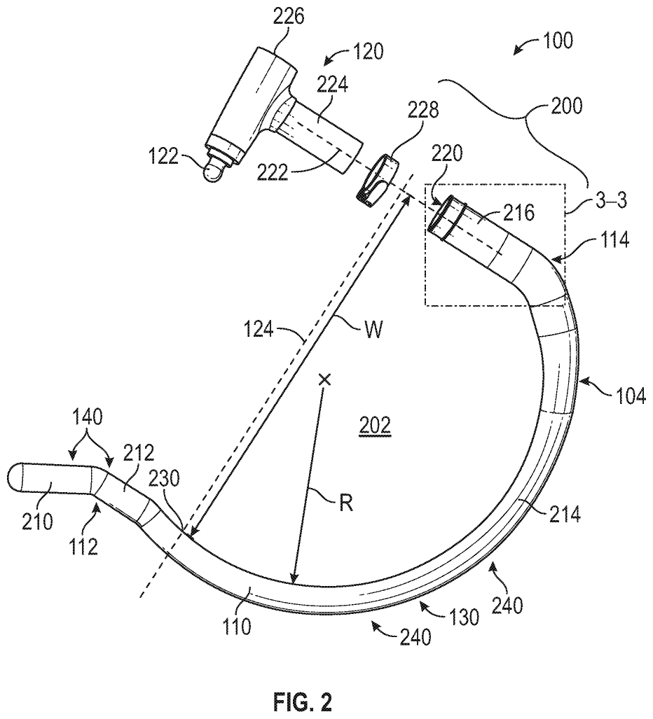

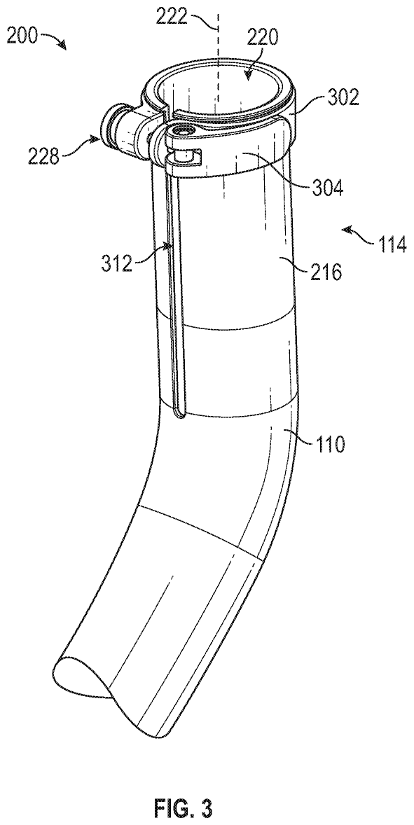

FIG. 1 shows a massager system 100 in accordance with one embodiment. Massager system 100 includes a handle 104 with an elongate body 110 having a first end portion 112 and a second end portion 114 at opposite ends of the elongate body 110. Massager system 100 further includes a massager gun 120 (also called a massage gun) mounted to the second end portion 114 of body 110. Massager gun 120 may be a battery-powered percussive massage gun, and may include a massager head 122 that reciprocates inward and outward along a reciprocation axis 124. As described in further detail with reference to FIGS. 2 and 3, body 110 of handle 104 has a shape between first end portion 112 and second end portion 114 that enables and accommodates ergonomic use by a human user 126.

In FIG. 1, massager system 100 is shown operated by user 126 in a lap-supported configuration by which body 110 is supported upon a lap 134 of the human user 126 while massager gun 120 is operated to reciprocate along axis 124 onto a targeted region 132 of the back 128 (posterior of torso) of the user 126. For example, in the lap-supported configuration of FIG. 1, first end portion 112 of body 110 is positioned in front of the user 126 while second end portion 114 of body 110 is positioned behind and proximal of the user's back 128 such that massager head 122 contacts the upper portion of user's back 128 and/or shoulders, and while a curved middle section 214 (FIG. 2) of an intermediate region 130 of the body 110 of handle 104 is supported upon the lap 134 of the user 126. In the lap-supported configuration illustrated, the first end portion 112 is spaced apart from the user 126 at a distance that allows the user to grasp first end portion 112 along a grip 140. In another similar mode of use, body 110 of massager system 100 may be supported on a seating surface on which the user 126 is seated, such as a cushion of a chair or sofa, or on a cushion positioned adjacent to the user.

FIG. 2 shows an exploded assembly view of massager system 100 of FIG. 1. Progressing from first end portion 112 to second end portion 114, handle 104 includes a straight segment 210 at first end portion 112 forming a portion of the grip 140, a transition segment 212 that joins straight segment 210 and may also form a portion of the grip 104, a curved middle segment 214 that joins transition segment 212, and a straight segment 216 at second end portion 114 that joins curved middle segment 214. An end portion of the curved middle segment 214 where it joins transition segment 212 may also form a portion of the grip 140. Some or all of the surface of the grip 140 may be textured or otherwise treated to improve grippability. For example, straight segment 210 and/or transition segment 212 may include ribbing, indentations, raised logos, a rubberized coating, foam coating and/or padding.

Body 110 is preferably hollow. Second end portion 114 of body 110 is also preferably hollow so as to define a receptacle 220 having a receptacle axis 222. The receptacle 220 is sized and shaped to receive or otherwise accommodate a handle 224 of massager gun 120, which may be slidably inserted into receptacle 220 along receptacle axis 222. Receptacle 220 can be used to mount massager gun 120 to second end portion 114 of body 110 in a fixed configuration. In the embodiment illustrated, handle 224 is cylindrical and receptacle 220 is a bore that is shaped to slidably receive handle 224. In other embodiments, handle 224 and receptacle 220 can have other shapes, such as oval, triangular, polygonal, or irregular cross-sectional shapes, and may be slidably connected in the manner illustrated in FIGS. 1-2 or joined in another manner. In some embodiments, massager system 100 may include one or more differently sized and/or differently shaped adapters (not illustrated) for mounting various models of massager guns having various different handle shapes. In some embodiments, the fit between handle 224 of massager gun 120 and receptacle 220 or adapters may be a slip fit, while in other embodiments it may be a friction fit. Massager gun 120 may include controls, such as an on-off switch, heater controls, and intensity controls, at a heel end or butt 226 of massager gun 120, allowing the controls to be accessed when massager gun 120 is assembled to and secured to second end portion 114 of body 110.

Receptacle axis 222 is orthogonal (or approximately orthogonal) to reciprocation axis 124 of massager head 122 of massager gun 120. Note that while FIG. 2 is an exploded view, the reciprocation axis 124 of massager head 122 is shown in FIG. 2 at the position where it would be in relation to handle 104 when massager gun 120 is assembled (as illustrated in FIG. 1). An enlarged detail view of region 3-3 of FIG. 2 is provided in FIG. 3, described below, detailing an embodiment of a mounting system 200 of handle 104 at second end portion 114, including the receptacle 220 and a clamp 228.

In FIG. 2, reciprocation axis 124 has been extended to illustrate that it intersects curved middle section 214 of body 110 at a point of intersection 230 proximate first end portion 112. In the example of FIG. 2, point of intersection 230 is located along curved segment 214 close to transition segment 212. Furthermore, reciprocation axis 124 intersects body 110 of handle 104 on an opposite side of curved middle section 214 from a point at which reciprocation axis 124 intersects receptacle axis 222.

Curved middle section 214 partially encircles or surrounds an interior region 202 (e.g., by approximately 180 degrees), such that point of intersection 230 is located on an opposite side of interior region 202 from the point at which reciprocation axis 124 intersections receptacle axis 222. A width W of interior region 202 along reciprocation axis 124 between point of intersection 230 and the point at which reciprocation axis 124 intersections receptacle axis 222 can be sized to accommodate a human user 126 within the interior region 202, in the lap-supported configuration shown in FIG. 1, while positioning the grip 140 in front of the user 126 in spaced-apart relation from the user's torso at a distance that allows the user 126 to manually grasp the grip 140 in an ergonomic manner, which facilitates placement of the massager gun against a targeted region 132 of the user's back 128 and control of massage pressure while also avoiding or reducing activation of the targeted muscles in the user's back 128. In addition to accommodating the human subject and ergonomic placement of the grip 140, the width W of interior region 202 can also be sized to accommodate a distance at which massager head 122 of FIG. 1 protrudes inward from the point at which reciprocation axis 124 intersects receptacle axis 222. For example, on most massager guns 120 the massager head 122 may have a protrusion in the range of approximately 4 to 8 inches from the receptacle axis 222. In some embodiments, the width W is in the range of approximately 20 to 40 inches, or more preferably in the range of 20 to 30 inches or in the range of 22 to 28 inches. Different sizes of handle 104 may be offered for different users (e.g., men, women, children), with each different sized handle (small, medium, large, extra-large, etc.) having a different width W of the interior region 202 and a different curvature of the curved middle section 214.

In some embodiments, the curvature of the curved middle section 214 may include region that is arcuate or semi-circular. In some embodiments, the body 110 may be U-shaped with the base of the U shape being the arcuate or semicircular portion of curved middle section 214 and with the leg or legs of the U shape being the first and second end portions 112, 114 of handle 104. For example, one of the legs of a U shape may be the second end portion 114 forming the receptacle 120. The arcuate or semi-circular portion of curved middle section 214 may have an inner radius R in the range of approximately 10 to 20 inches, or more preferably in the range of 11 to 16 inches. The curvature of the arcuate or semicircular portion may be simple and of a constant radius, or may be a variable radius curve having a varying radius across its length. In either case, the radius of curvature R may be within the ranges of radiuses described above. The arcuate portion may have an included angle (central angle) in the range of 120 to 220 degrees or more preferably in the range of approximately 160 to 200 degrees. In some embodiments, the point of intersection 230 may be within the arcuate portion of the curved middle section 214, whether a simple constant-radius arc or variable-radius curve. In other embodiments, the point of intersection 230 may be outside of the curved middle section 214, such as in one of the straight sections of first end portion 112.

As shown in FIG. 2, straight segment 210 and transition segment 212 of body 110 are located on an opposite side of point of intersection 230 from the remainder of curved middle section 214, including a portion of curved middle section 214 that corresponds to intermediate region 130 of FIG. 1. For example, in FIG. 2, a convex side 240 of curved middle section 214 is located at or within intermediate region 130 of FIG. 1. Convex side 240 of curved middle section 214 can contact the lap 134 of the user 126 in the lap-supported mode of use, such as shown in FIG. 1. Accordingly, massager system 100 can be supported upon the lap 134 of user 126 along convex side 240 of curved middle section 214. In some use modes, supporting the massager system 100 on the user's lap 134 or on an adjacent support surface may facilitate one-handed operation via grip 140. In some use modes, a user may further provide lateral support for massager system 100 by placing their arm and hand over curved middle section 214 as illustrated in FIG. 1. The unique Body Arc™ configuration of handle 104 is engineered to optimize the angle and point of application of the massager gun 120, while simultaneously supporting its weight. For example, as illustrated in FIG. 1, while curved middle section 214 is supported on a user's lap 134, the user may apply massager gun 120 to the left side of their back 128 using their right hand on the grip 140 and leaving the left forearm in a neutral position, resting on the arcuate curved middle section, to thereby avoid triggering, activating, or engaging the muscles in the left side of their back to facilitate relaxation and therapeutic efficacy. Similarly and alternatively, the user may use their left hand to hold the grip 140 while applying the massager gun 120 to the right side of their back 128, while leaving the right arm in a neutral position over the curved middle section 214 to avoid triggering muscles in the right side of their back 128.

In a further method of use, the curved middle section 214 may be laid flat in the user's lap across both legs in a generally horizontal plane while positioning the massager gun 120 against the user's lower back; then, while spreading their legs apart beneath the curved middle section 214, the user may press their forearms on the curved middle section between their legs to rotate the curved middle section 214 so that a base (trough) of the curved middle section 214 moves downwardly between their legs. At the same time as pressing the trough of curved middle section 214 downwardly, the handle 104 is inclined so that the first and second end portions 112, 114 are moved upwardly to move the massage gun 120 upwardly along the user's back 128. In this manner, massage may be applied in a hands-free mode without grasping the handle 104.

In some embodiments, handle 104 or first end portion 112 may be weighted (e.g. with metal weights inserted into the handle 104 or first end portion 112 thereof) to help further stabilize the handle 104 and/or to provide a counterweight to massager gun 120 to improve the balance of the massager system 100.

Convex side 240 features a continuous curve over the entirety of curved middle section 214 to allow the user to slide the convex side 240 over the user's lap 134 to facilitate positioning of the massager head 122 of massager gun 120 in contact with various positions along the user's back, from the user's lower back to their neck. The curved middle section 214 and convex side 240 may be sized and shaped to allow the massager system 100 to be rocked about a contact location where convex side 240 contacts and rests on the user's lap 134. The curved middle section 214 and convex side 240 may further be sized and shaped so that sliding the convex side 240 of the user's lap 134 (e.g. via manipulation of handle 104 via grip 140) causes the contact location to move along a substantial portion the curved middle section 214. In this manner, the user 126 can adjust a positioning of massager head 122 relative to the back 128 of the user 126 by rocking and/or sliding convex side 240 upon and/or along their lap. The contact location between the convex side 240 and the user's lap 134 or an adjacent supporting surface may also provide a pivot point or fulcrum for mechanical leverage, facilitating the transmission forces from grip 140 to massage head 122 with reduced muscular effort. Contact between the convex side 240 and the user's lap 134 or an adjacent supporting surface may also help to absorb and/or attenuate vibrations caused by massager gun 120 and to reduce their transmission to the first end portion 112 and grip 140.

The smoothly curved convex side 240 of curved middle section 214 of handle 104 allows the position of massager head 122 to be adjusted along the user's back 128 while maintaining even pressure against the muscles of the user's back and smooth application of percussive massage or other kinds of massage by massager gun 120 from the lower back to the neck of a human user. The shape and size of the curved middle section 214 and/or convex side 240 may allow the massager gun to be maintained in continuous contact with the user's back while sliding the convex side 240 over the user's lap 134 to reposition the massager gun 120 relative to the user's back 128. The unique construction permits the weight of massager system 100 to rest upon the user's lap 134, providing a more relaxed posture and reducing or even eliminating the need to engage the targeted muscle groups.

Designed for universal applicability, handle 104 of massager system 100 can accommodate most percussion massagers with round and universal chucks (massager mounts). The size and shape of body 110 of handle 104 may further facilitate use of massager system 100 for massaging the feet of the user by supporting the body 110 of handle 104 on a floor or other support surface, and placing the user's feet over the massager head 122.

FIG. 3 is an enlarged detail view of region 3-3 of FIG. 2, showing details of mounting system 200 at second end portion 114 of handle 104 for mounting massager gun 120 to the handle 104. In this example, receptacle 220 has a circular cross section. However, as mentioned above, in other embodiments receptacle 220 can have a non-circular cross section. In this example, second end portion 114 includes a longitudinal slit 312 that allows second end portion 114 to deform around and compress onto the handle 224 of massager gun 120. Mounting system 200 may further include clamp 228, such as a post clamp, which includes a band 302 that at least partially encircles second end portion 114, and a quick release cam lever 304 for drawing together ends of the band 302 in a clamping action to tighten the band 302 around second end portion 114 and secure the handle 224 of massager gun 120 within the receptacle 220. The presence of slit 312 facilitates the clamping action. Cam lever 304 may be manually released to unclamp the mounting system 200 and allow massager gun 120 to be removed from receptacle 220. In alternative embodiments, the clamp 228 may be omitted and massager gun 120 may be secured to second end portion 114 by a friction fit or other means. Mounting system 200 and receptacle 220 may be configured to tightly hold massager gun 120 and prevent it from rotating relative to handle 140. In some embodiments, to provide improved grip between the receptacle 220 and massager gun 120, when clamped, the receptacle 220 may be lined with a resilient material such as an elastomeric sleeve inserted into receptacle 220, or lined with a ridge, protrusion, or other features. The receptacle 220 and elastomeric lining may be sized and selected to allow the massager gun to be selectively rotated relative to handle 104 when the clamp 228 is unclamped. In other embodiments, a different kind of rotational interface may be included in mounting system 200 for allowing the rotational position of massager gun 120 to be selectively adjusted and fixed relative to handle 104. The depth to which the handle 224 of massager gun 120 is inserted into the receptacle 220 may also be selected or adjusted to accommodate users of somewhat different heights and sizes.

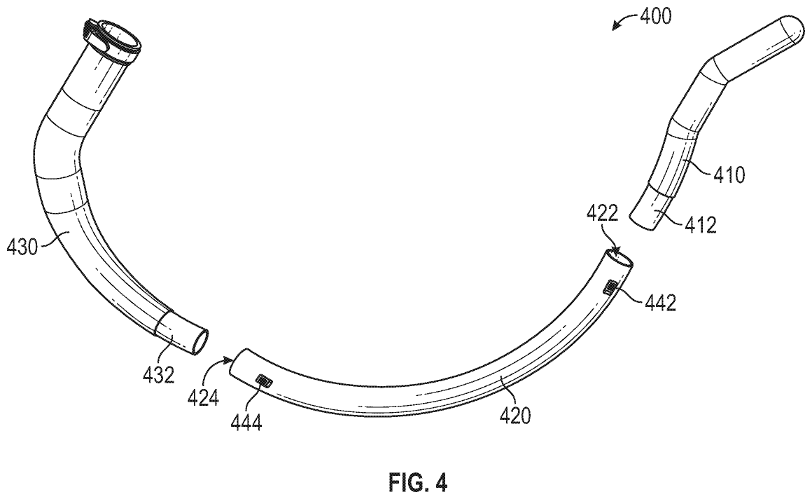

Handle 104 may be formed of metal or polymer material. For example, handle 104 may be blow-molded or injection molded of a polymer resin, such as polyethylene terephthalate (PET), high density polyethylene (HDPE), nylon, polypropylene, polycarbonate, or another thermoplastic or thermoset polymer material. Molding the handle 104 of plastic allows for formation of the receptacle 220, curved middle section 214 and the grip 140 in a unitary one-piece body 110 having different diameters in various regions, wherein the grip 140 may have a diameter in the range of approximately 1.0 to 1.75 inches, and more preferably between about 1.25 and 1.6 inches; the curved middle section 214 may have a diameter in the range of approximately 1.25 to 2.0 inches, and more preferably between 1.4 and 1.8 inches for design strength and spring properties; and the receptacle 220 may have a diameter in the range of approximately 1.5 to 3.25 inches, or more preferably 1.75 to 2.25 inches, and an inner diameter sized to accommodate the handle 224 of massager gun 120. The various diameters may also be possible in a multi-section handle design of the kind described below with reference to FIG. 4, via the use of smooth transitions between different diameters. The handle 104 may have a wall thickness that is relatively consistent throughout and in the range of approximately 0.175 to 0.225 inches. In some embodiments, the material from which handle 104 is made may be flexible, compliant, and resilient to act as a spring that reduces the transmission of vibrations from massager gun 120 to grip 140. Careful design of the handle 104 and selection of materials, may provide a spring constant, and sufficient spring force and compliance, to provide adequate massage pressure while preventing the massager head 122 from uncomfortably bouncing on the user's back 128 when a user applies modest to heavy force or pressure against the grip 140 or handle 104. For example, the body 110 of handle may have a spring constant in the range of 400 N/m to 2000 N/m, or between 500 N/m and 1500 N/m, or between 500 N/m and 1000 N/m. The body 110 and particularly the curved middle section 214 may be resilient and sufficiently flexible to allow the first end portion 112 to be manually deflected at least 10 cm relative to its resting position while the second end portion 114 is held in place, for example by placing the massager head 122 against the user's back 128 and manually pushing first end portion 112 forwardly. In other embodiments, handle 104 may be formed of metal, fiber composite, or another rigid material that is much less flexible than described above. Hybrid constructions of metal and/or polymer and/or composite materials is also possible.

In some embodiments, elongate body 110 or a portion thereof may contain or be filled with a dampening material, such as foam, gel, rubber, or other elastomeric material, which may be positioned within the hollow elongate body 110 to attenuate or absorb a portion of vibrations generated by massager gun 120 and/or to reduce the transmission of such vibrations to first end portion 112 and grip 140. In one embodiment, a dampening foam or elastomeric material may be injected into elongate body 110 via receptacle 220 or via a port (not shown) in a side of body 110.

FIG. 4 illustrates a three-piece curved ergonomic handle 400 for a massager system in accordance with another embodiment. With reference to FIG. 4, handle 400 includes multiple separable pieces or sections that can be assembled together to form the complete handle 400. The shape and portions of handle 400 may otherwise be essentially the same as handle 104. The multi-piece construction of handle 400 allows it to be broken down for storage when not in use, or for transport. In the example shown, the handle 400 is made up of three segments or sections-a first end section 410, a middle section 420, and a second end section 430. In other embodiments the handle may be made of a greater number of sections or of only two sections. Each of the sections 410, 420, 430 may be made of a molded polymer material, composite material, or metal, or combinations thereof. The three sections 410, 420, 430 of handle 400 are illustrated with slip fit joints comprised of smaller-diameter ferrules 412, 432 and receiving sockets 422, 424 into which the ferrules 412, 432 are inserted for assembly. Each joint may be provided with a locking mechanism, such as a latching tab 422, 444 that locks together adjacent sections when assembled, and which may be manually depressed to release the tab and allow disassembly of the sections 410, 420, 430. In other embodiments, the locking mechanism may comprise a twist lock connector, friction clamping ring, or other mechanism. In other embodiments, the adjacent sections 410, 420, 430 may be connected by other forms of connectors. The connectors of sections 410, 420, 430 may include an orientation feature for aligning adjacent sections during their connection and/or for maintaining alignment between the adjacent sections when connected.

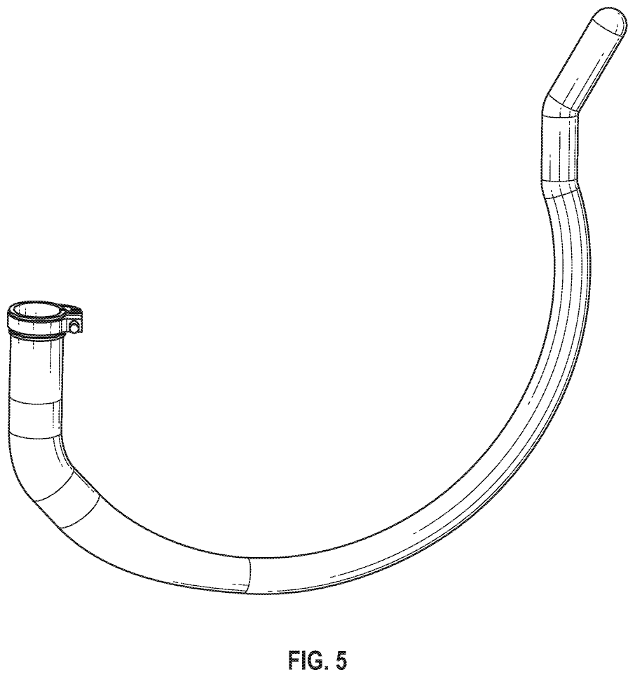

FIGS. 5-10 further illustrate the ornamental appearance, shape, and configuration details of the handle 104 of FIGS. 1-3, with the massager gun 120 omitted.

Embodiments of the massager system 100 may also be realized as a method of self-massage, comprising the steps of:
(1) fixing a massager gun to a mounting system such as mounting system 200, wherein mounting system 200 is at a second end portion of an elongate body 110 that includes a curved middle section 214 extending between the second end portion 114 and a first end portion 112 of the elongate body 110 opposite the second end portion 114;
(2) positioning the elongate body 110 such that the second end portion 114 is positioned proximate a user's back 128 for application of the massager gun 120 to a targeted region 132 on the user's back 128 while a convex side 240 of the curved middle section 214 rests on the user's lap 134 and the entire first end portion 112 is positioned in front of the user 126 and spaced apart from the user at a distance that allows the user to grasp the first end portion 112 for positioning the massager gun 120 in contact with the targeted region 132, and wherein the convex side 240 of the curved middle section 214 is continuously curved over the entire curved middle section 214; and
(3) manipulating the elongate body 110 to slide the convex side over the user's lap 134 to thereby position the massager gun 120 in contact with the user's back 128 at various positions between the user's lower back and their neck.

In some embodiments, the method may further comprise rocking the elongate body 110 about a contact location where the convex side 240 rests on the user's lap 134. And in some embodiments, the method may further comprise sliding the convex side 240 over the user's lap 134 so as to cause the contact location to move along the curved middle section 214 while maintaining continuous contact between the massager gun 120 and the user's back 128.

In some embodiments, the method may further comprise adjusting a rotational position of the massager gun 120 relative to the body 110 and re-securing the massager gun 120 to the body 110.

In some embodiments, the method may further comprise assembling the body 110 from multiple component sections and/or disassembling the body 110 into the component sections for storage and/or transport.

It will be understood that the configurations and/or approaches described herein are exemplary in nature, and that these specific embodiments or examples are not to be considered in a limiting sense, because numerous variations are possible. Those having skill in the art will appreciate that many changes may be made to the details of the above-described embodiments without departing from the underlying principles of the invention. The subject matter of the present disclosure includes all novel and non-obvious combinations and sub-combinations of the various methods, systems and configurations, and other features, functions, acts, and/or properties disclosed herein, as well as any and all equivalents thereof. The scope of the invention should, therefore, be determined only by the following claims.

The invention claimed is:

1. A self-massage apparatus for applying a powered massager gun to a targeted region of a human user's back, comprising:
an elongate body having opposite first and second end portions, the first end portion being graspable by a user of the apparatus; and
a mounting system at the second end portion for fixing a powered massager gun to the second end portion,
wherein the elongate body further includes a curved middle section extending between the first and second end portions, the curved middle section being sized and shaped so that, when the massager gun is fixed to the mounting system, the second end portion is positionable proximate the user's back for application of the massager gun to the targeted region while a convex side of the curved middle section rests on the user's lap and the entire first end portion is positioned in front of the user and spaced apart from the user at a distance that allows the user to grasp the first end portion for positioning the massager gun in contact with the targeted region, and
wherein the convex side of the curved middle section is continuously curved over the entire curved middle section so as to allow the user to slide the convex side over the user's lap to facilitate positioning of the massager gun in contact with the user's back at various positions between the user's lower back and their neck.

2. The apparatus of claim 1, wherein the curved middle section is sized and shaped to allow the apparatus to be rocked about a contact location where the convex side rests on the user's lap.

3. The apparatus of claim 2, wherein the curved middle section is sized and shaped so that sliding the convex side over the user's lap causes the contact location to move along the curved middle section.

4. The apparatus of claim 3, wherein the curved middle section is sized and shaped so that the massager gun may be maintained in continuous contact with the user's back while sliding the convex side over the user's lap to reposition the massager gun relative to the user's back at locations from the user's lower back to their neck.

5. The apparatus of claim 1, wherein the curved middle section has an inner radius in the range of approximately 10-20 inches.

6. The apparatus of claim 1, wherein the elongate body is formed of a polymer resin.

7. The apparatus of claim 6, wherein the polymer resin is selected from the group consisting of HDPE, polypropylene, nylon, polycarbonate, and a thermoplastic polymer.

8. The apparatus of claim 1, wherein the curved middle section is resilient and sufficiently flexible to allow the first end portion to be manually deflected at least 10 cm relative to its resting position while the second end portion is held in place.

9. The apparatus of claim 1, wherein the elongate body has a spring constant in the range of 400 N/m to 2000 N/m.

10. The apparatus of claim 1, wherein the elongate body comprises multiple sections that are detachably connected.

11. The apparatus of claim 10, further comprising slip-fit connectors that connect adjacent ones of the sections.

12. The apparatus of claim 10, wherein the sections include connectors with orientation features to maintain alignment of the sections, when connected.

13. The apparatus of claim 1, wherein the second end portion is hollow and sized to receive a handle of the massager gun.

14. The apparatus of claim 13, wherein the second end portion includes a longitudinal slit and the mounting system includes a band and a releasable clamp that clamps the band around the second end portion to fix the second end portion to the handle of the massager gun.

15. The apparatus of claim 13, wherein the massager gun includes controls at a butt of the massager gun to allow the user to switch the massager gun on and off while the handle of the massager gun is received in and secured to the second end portion.

16. The apparatus of claim 1, wherein the elongate body is hollow.

17. The apparatus of claim 16, further comprising a dampening material positioned within the elongate body to absorb a portion of vibrations caused by the massager gun and to reduce transmission of such vibrations to the first end portion.

18. A method of self-massage, comprising:
fixing a massager gun to a mounting system at a second end portion of an elongate body that includes a curved middle section extending between the second end portion and a first end portion of the elongate body opposite the second end portion;
positioning the elongate body such that the second end portion is positioned proximate a user's back for application of the massager gun to a targeted region on the user's back while a convex side of the curved middle section rests on the user's lap and the entire first end portion is positioned in front of the user and spaced apart from the user at a distance that allows the user to grasp the first end portion for positioning the massager gun in contact with the targeted region, and wherein the convex side of the curved middle section is continuously curved over the entire curved middle section; and
manipulating the elongate body to slide the convex side over the user's lap to thereby position the massager gun in contact with the user's back at various positions between the user's lower back and their neck.

19. The method of claim 18, further comprising:
rocking the elongate body about a contact location where the convex side rests on the user's lap; and
sliding the convex side over the user's lap so as to move the contact location along the curved middle section while maintaining continuous contact between the massager gun and the user's back.

20. The ornamental design for an extension handle for a massager system as shown in FIGS. 5-10 and described in the brief description of FIGS. 5-10.
